(19) United States
(12) Patent Application Publication
(10) Pub. No.: US 2016/0174765 A1
(43) Pub. Date: Jun. 23, 2016

(54) TOP HEATING TYPE COOKING APPARATUS

(71) Applicant: Yoon Jae CHO, Seoul (KR)

(72) Inventor: Yoon Jae CHO, Seoul (KR)

(21) Appl. No.: 14/819,453

(22) Filed: Aug. 6, 2015

(30) Foreign Application Priority Data
Dec. 18, 2014 (KR) 20-2014-0009381

(51) Int. Cl. A47J 37/06

(52) U.S. Cl. CPC A47J 37/0688

(57) ABSTRACT

Disclosed herein is a top heating type cooking apparatus comprising: a support unit 102 which has a coupling fixed groove 14 on the top surface of a support plate 10 in the form of a flat panel; a pillar unit 104 which includes a fixing pillar 16 fixed to a back of the support unit 102, and a connection pillar body 22 upwardly extended and installed in the fixing pillar 16, and which has hinge units 103 and 105 so that the top and bottom of the fixing pillar 16 and the connection pillar body 22 are hinged and rotatably moved; a heating unit 106 which is connected to the hinge unit 105 of the pillar unit 104 to be rotatably moved up and down and which provide heat to broil cooking materials from the top; a position adjustment link unit 110 which is inserted and rotated into a coupling fixing groove 14 formed in the top surface of the support unit 102 and which is installed to fix the position of the cooking materials and to move up and down so that the cooking materials become close to the heater unit 106; and a material support tool 112 which is fixed to the top of the position adjustment link unit 110 and which includes a material support body 56 and a side plate 58 to place and broil the cooking materials therein.

### CROSS-REFERENCE TO RELATED APPLICATION(S)

This application claims the benefit of Korean Utility Model Application No. 20-2014-0009381, filed on Dec. 18, 2014, which is hereby incorporated by reference herein in its entirety.

### BACKGROUND

1. Technical Field

The present invention relates to a top heating type cooking apparatus and, more particularly, to a top heating type cooking apparatus capable of cooking materials, such as boiled potatoes, french fries, sausages, cheese, or hot dogs, by broiling the cooking materials using heat directed from the top and cutting or slicing the broiled materials from the top.

2. Description of the Related Art

In general, cooking apparatuses have used charcoal fire, gas, or electricity as a heat source in order to broil a cooking material such as meat or fish or boil types of stew in a container in private homes or public restaurants.

However, when cooking boiled potatoes, sweet potatoes, cheese, sausages, and french fries, cases where an upper heating system is used are rare, and in the majority of cases, a lower heating system is used.

Given the above circumstances, the applicant of the present application has developed a top heating type cooking apparatus configured to apply a heat source to the cooking materials from the top and broil the lower part of the materials.

### SUMMARY

Accordingly, the present invention has been made keeping in mind the above problems encountered in the related prior arts, and an object of the present invention is to provide a top heating type cooking apparatus, which is capable of cooking materials, such as boiled potatoes, french fries, cheese, hot dogs, or sausages, by broiling the cooking materials using an upper heat source from the top to the bottom and, if the bottom is broiled, cutting or scraping the cooked materials using cutting means, such as a knife.

In order to accomplish the above objects, an embodiment of the the present invention provides a top heating type cooking apparatus, comprising: a support unit 102 which has a coupling fixed groove 14 on the top surface of a support plate 10 in the form of a flat panel; a pillar unit 104 which includes a fixing pillar 16 fixed to the back of the support unit 102, and a connection pillar body 22 upwardly extended and installed in the fixing pillar 16, and which has hinge units 103 and 105 so that the top and bottom of the fixing pillar 16 and the connection pillar body 22 are hinged and rotatably moved; a heating unit 106 which is connected to the hinge unit 105 of the pillar unit 104 to be rotatably moved up and down and which provides heat to broil cooking materials from the top; a position adjustment link unit 110 which is inserted and rotated into a coupling fixing groove 14 formed in the top surface of the support unit 102 and which is installed to fix the position of the cooking materials and to move up and down so that the cooking materials become close to the heater unit 106; and a material support tool 112 which is fixed to the top of the position adjustment link unit 110 and which includes a material support body 56 and a side plate 58 to place and broil the cooking materials therein.

In another embodiment of the present invention, the top heating type cooking apparatus may further include a material fixing body 68 configured to apply lateral pressure to the cooking materials to fix them, wherein an advance bar 70 and a handle 72 are formed on one side of the material fixing body 68 and material fixing means 114 configured to move back and forth by rotating the handle 72, and apply pressure to fix the cooking materials.

In another embodiment of the present invention, the position adjustment link unit 110 may include a bearing 38 inserted into the coupling fixing groove 14 and rotated, a bearing shaft 40 combined with the bearing 38, a connection link 42 fixed to the top of the bearing shaft 40 and laterally extended, and an elevation bar 44 fixed to one end of the connection link 42 and upwardly extended.

In another embodiment of the present invention, the top heating type cooking apparatus may further include a fixing piece 62 configured to be in a a triangle shape and be fixed to the inside of the material support body 56 of the material support tool 112.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating the structure of a top heating type cooking apparatus according to the present invention;

FIG. 2 is an exploded perspective view illustrating the structure of the top heating type cooking apparatus according to the present invention;

FIG. 3 is a front view of the top heating type cooking apparatus according to the present invention;

FIG. 4 is a side view of the top heating type cooking apparatus according to the present invention;

FIG. 5 is a perspective view illustrating the bottom of the top heating type cooking apparatus according to the present invention when viewed from the bottom; and

FIG. 6 is a perspective view illustrating a state where the top heating type cooking apparatus according to the present invention is used.

### DETAILED DESCRIPTION

A top heating type cooking apparatus according to the present invention may comprise: a support unit 102 which has a coupling fixed groove 14 on the top surface of a support plate 10 in the form of a flat panel; a pillar unit 104 which includes a fixing pillar 16 fixed to the back of the support unit 102, and a connection pillar body 22 upwardly extended and installed in the fixing pillar 16, and which has hinge units 103 and 105 so that the top and bottom of the fixing pillar 16 and the connection pillar body 22 are hinged and rotatably moved; a heating unit 106 which is connected to the hinge unit 105 of the pillar unit 104 to be rotatably moved up and down and which provides heat to broil cooking materials from the top; a position adjustment link unit 110 which is inserted and rotated into a coupling fixing groove 14 formed in the top surface of the support unit 102 and which is installed to fix the position of the cooking materials and to move up and down so that the cooking materials become close to the heater unit 106; and a material support tool 112 which is fixed to the top of the position adjustment link unit 110 and which includes a material support body 56 and a side plate 58 to place and broil the cooking materials therein.

Preferred embodiments of the top heating type cooking apparatus according to the present invention are described below. The merits and characteristics of the present invention and a method for accomplishing the merits and characteristics will become more apparent from embodiments described in detail later in conjunction with the accompanying drawings.

However, the present invention is not limited to the disclosed embodiments, but may be implemented in various different ways. The embodiments are provided only to complete the disclosure of the present invention and to allow those skilled in the art to understand the scope of the present invention. The present invention is only defined by the claims.

Furthermore, in describing the present invention, if known functions and constructions are deemed to make the gist of the present invention unnecessarily complex, the detailed description thereof will be omitted

On the contrary, the embodiments introduced herein are intended to make the disclosed contents thorough and complete and to sufficiently convey the spirit of the present invention to those skilled in the art.

Terms, such as first and second, may be used to describe various elements, but the elements should not be restricted by the terms. The terms are used only to distinguish one element from another element. For example, a first element may be referred to as a second element without departing from the scope of the present invention. Likewise, a second element may be referred to as a first element.

Terms, such as top, bottom, upper side, lower side, upper part, and lower part, are used to distinguish the relative location of elements. For example, if an upper side of a figure is referred to as an upper part and a lower side of the figure is referred to as a lower part for the sake of convenience, the upper part may be referred to as the lower part and the lower part may be referred to as the upper part without departing from the scope of the present invention.

The terms used in this application are used to only describe particular embodiments and are not intended to restrict the present invention. An element that is referred to in the singular also includes a plurality of elements unless clearly defined otherwise in context. In this application, terms, such as “comprise” or “have”, are intended to designate that characteristics, numbers, steps, operations, elements, or parts which are described in the specification, or a combination thereof, and should not be understood to exclude the existence or possible addition of one or more other characteristics, numbers, steps, operations, elements, parts, or combinations thereof.

All terms used herein, including technical or scientific terms, unless otherwise defined, have the same meanings as those typically understood by those having ordinary skill in the art. The terms, such as those defined in common dictionaries, should be interpreted to have the same meaning as in the context of pertinent technology, and should not be interpreted to have an ideal sense or verbalism unless clearly defined in the specification.

Hereinafter, embodiments of the top heating type cooking apparatus according to the present invention are described with reference to the drawings, but the present invention is not limited to such embodiments and may be implemented in various ways. Furthermore, it is to be noted that the top heating type cooking apparatus may be applied to various uses and purposes.

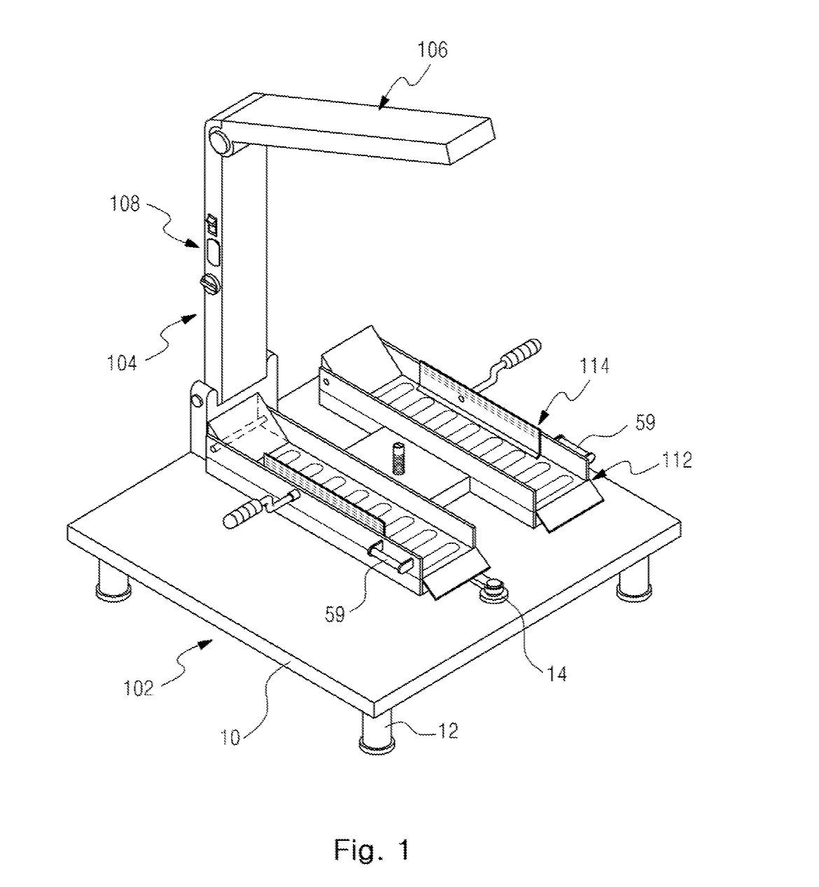

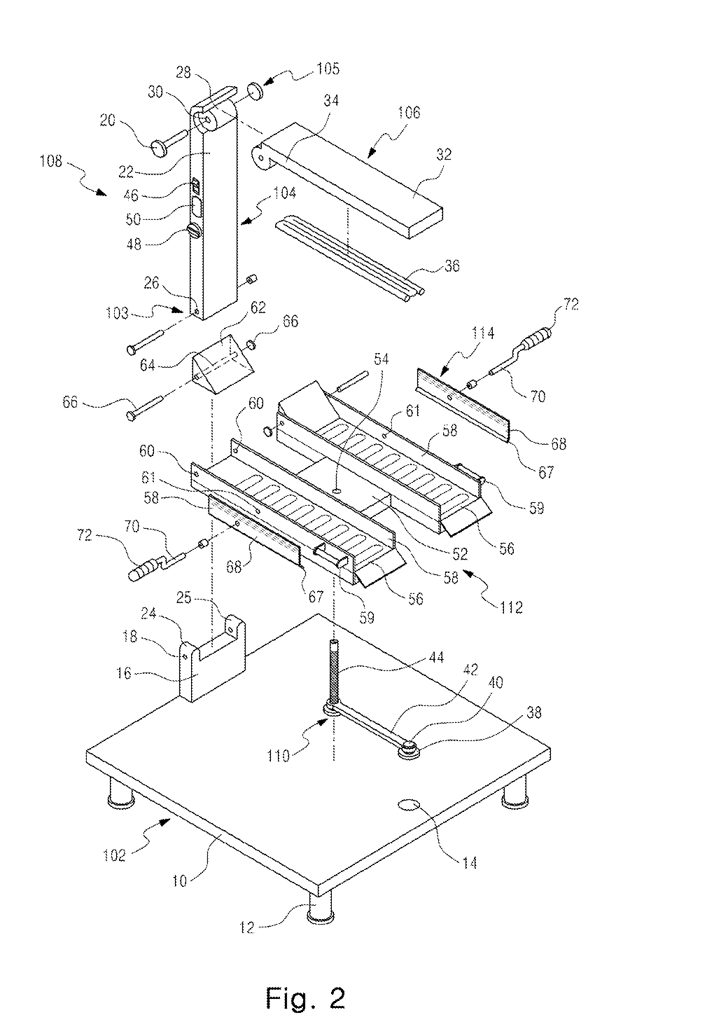

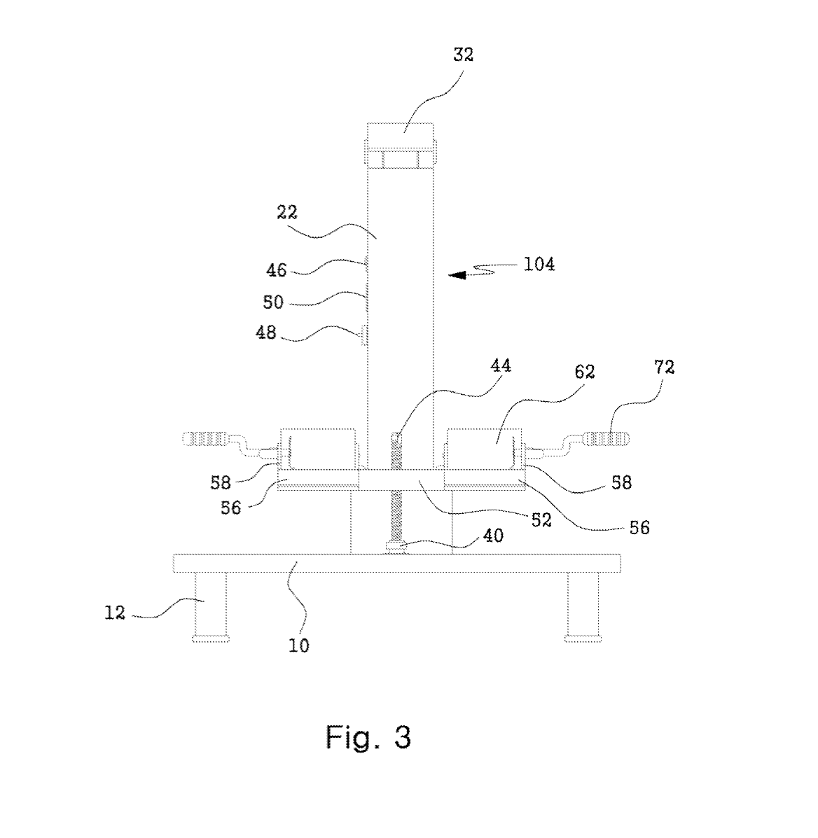

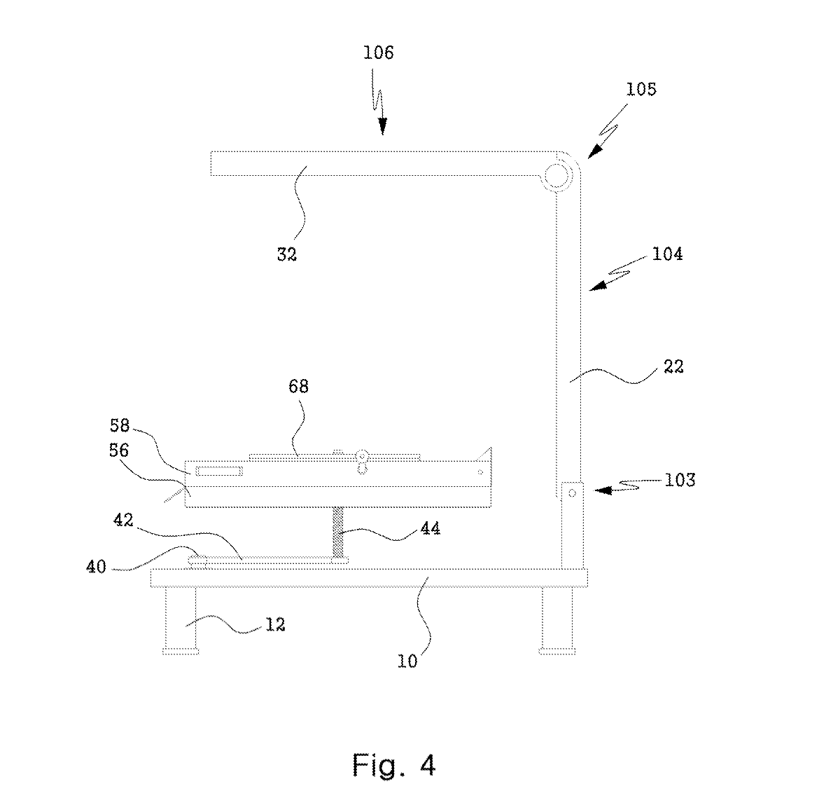

FIG. 1 is a perspective view illustrating the structure of a top heating type cooking apparatus according to the present invention. FIG. 2 is an exploded perspective view illustrating the structure of the top heating type cooking apparatus according to the present invention. FIG. 3 is a front view of the top heating type cooking apparatus according to the present invention. FIG. 4 is a side view of the top heating type cooking apparatus according to the present invention.

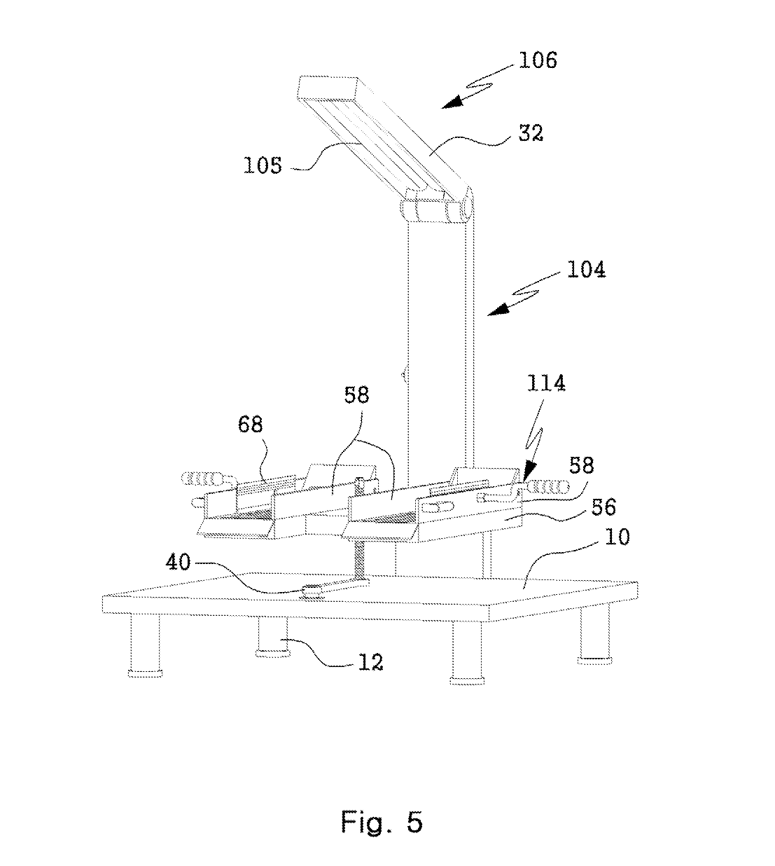

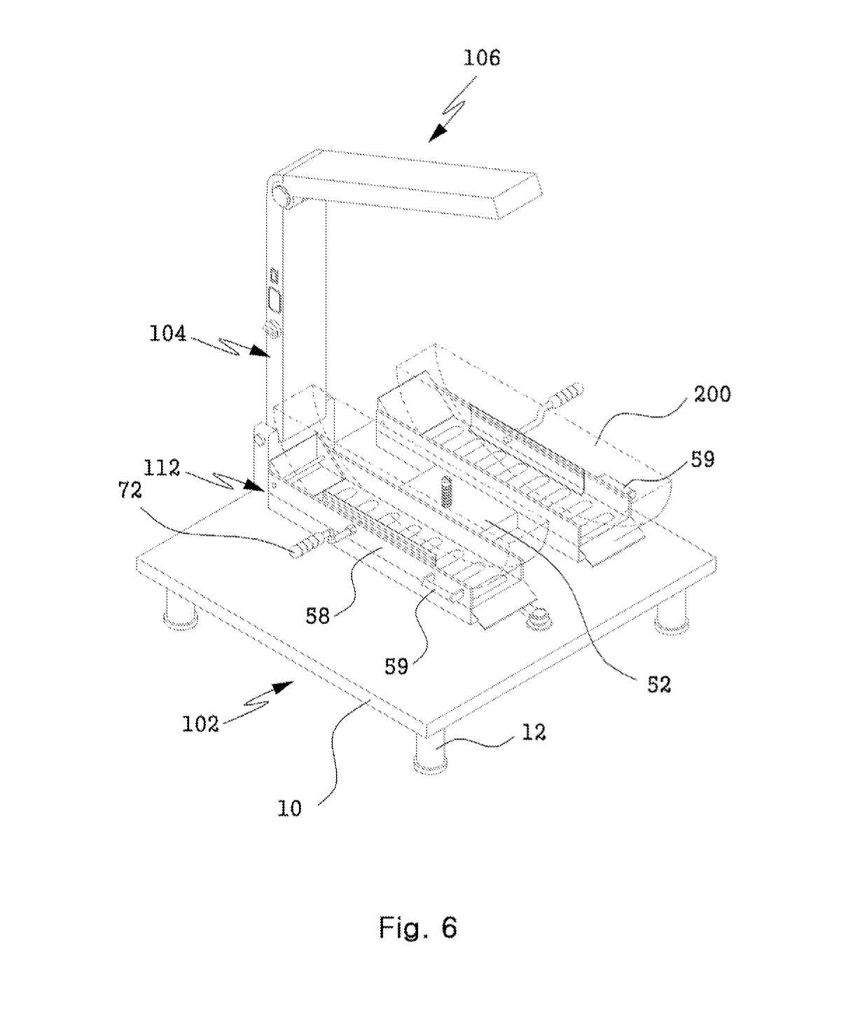

Furthermore, FIG. 5 is a perspective view illustrating the bottom of the top heating type cooking apparatus according to the present invention when viewed from the bottom. FIG. 6 is a perspective view illustrating a state where the top heating type cooking apparatus according to the present invention is used.

FIGS. 1 to 6 clearly illustrate only major characteristics so that the concept of the present invention may be understood clearly. It is anticipated that the figures may be modified in various ways, and the scope of the present invention need not be limited to a particular shape shown in the figures.

First, the description is given with reference to FIGS. 1 and 4.

As illustrated in FIG. 1, the top heating type cooking apparatus 100 according to the present invention includes a support unit 102 in the form of a rectangular flat panel. The support unit 102 is installed with a pillar unit 104 that is configured to be upwardly protruded and extended from the rear upper part of the support unit.

It is preferred that the support unit 102 is formed to support the pillar unit 104.

The pillar unit 104 stands vertically upright. A heating unit 106 for applying heat may be included at the top of the pillar unit 104. The heating unit 106 applies heat to cooking materials, such as boiled potatoes, french fries, hot dogs, cheese, or sausages and cooks the materials from the top.

The heating unit 106 may include an electric heater or a gas heater and may further include a halogen heater using a halogen lamp.

The pillar unit 104 has at least two hinge units 103 and 105, and may be preferably installed so as to be rotatably moved back and forth around the hinge units.

A temperature control unit 108 may be preferably provided on one side of the pillar unit 104, preferably on the left side of the pillar unit 104.

The temperature control unit 108 may be preferably installed so as to apply heat to cooking materials by controlling the temperature of the heating unit 106 or may be installed so as to allow a user to control the temperature of the heating unit 106 by turning a dial.

Furthermore, a position adjustment link unit 110 may be provided on the top of the support unit 102. The position adjustment link unit 10 is installed so as to rotatably move cooking materials along the left and right sides or control the cooking materials upwardly and downwardly, so that the cooking materials become close to the bottom of the heater unit 106.

The position adjustment link unit 110 is connected and fixed to a material support tool 112.

The material support tool 112 has a shape of “ [symbol] ” so that the cooking materials are placed thereon. The material support tool 112 may be preferably installed so as to rotate along the left and right sides or move up and down in conjunction with the position adjustment link unit 110.

Meanwhile, the material support tool 112 has a material fixing means 114 for fixing various cooking materials.

The material fixing means 114 is configured to move left and right by rotation of a handle and installed to secure cooking materials placed on the material support tool 112 by applying pressure to the cooking materials on one side-either the left side or the right side.

The cooking apparatus 100 configured as described above is installed in such a manner that cooking materials are placed on the material support tool 112. The cooking apparatus 100 is placed at a position close to the bottom of the heating unit 106 using the position adjustment link unit 110, and electricity or heat is applied to the heating unit 106 and it is transferred from the top to the bottom and the cooking materials are broiled from the top to the bottom.

In this case, the heating unit 106 for supplying the heat source is configured so that its position is adjusted by moving the hinge units 103 and 105 of the pillar unit 104 back and forth and so that a heat source is applied to cooking materials at the most appropriate position.

The cooking materials used may include materials of a lump shape. That is, lumps of meat or lumps of cheese may be used. In particular, half-moon-shaped lumps of cheese may be cooked by applying heat thereto from the top and scraping them using a knife.

Below, the cooking apparatus is more specifically described with reference to FIGS. 2 to 5. The support unit 102 includes a support plate 10 in the form of a rectangular flat panel. Legs 12 are formed at four corners of the bottom of the support plate 10. A coupling fixed groove 14 is formed in the top surface of the support plate 10.

Furthermore, the pillar unit 104 is vertically protruded from top of the support plate 10 at the back of the support plate 10. The pillar unit 104 has a fixing pillar 16 formed on the top surface of the support plate 102 at the back of the support plate 102. A hinge hole 18 penetrates the fixing pillar 16 along the left and right sides. A fixing means 20, such as a bolt, piece, rivet, or pin, is inserted into the hinge hole 18.

A connection pillar body 22 is upwardly extended and fixed to the fixing pillar 16.

Hinge pieces 24 and 25 are symmetrically formed on both sides of the top of the fixing pillar 16. A hinge hole 26 is formed so that it penetrates the hinge pieces 24 and 25 along the left and right sides.

The hinge pieces 24 and 25 are connected to the bottom of the connection pillar body 22 to be described below. The hinge hole 26 is placed at the same position as the fixing hole 18 and is connected to the connection pillar body 22 by the fixing means 20. The connection pillar body 22 connected by the fixing means 20 may perform a back and forth rotary operation around the fixing means 20.

Hinge coupling units 28 and 29 are formed on the top of the connection pillar body 22. A hinge hole 30 is formed to penetrate the hinge coupling units 28 and 29 left and right. The fixing means 20 is connected to the hinge hole 30. Furthermore, the hinge connection unit 34 of the heating body 32 is connected to the hinge coupling units 28 and 29 so that the heating body 32 rotatably moves up and down.

The heating unit 106 for heating and broiling the cooking materials is installed on top of the connection pillar body 22, that is, in the hinge pieces 28 and 29. The heating unit 106 includes the heating body 32 in the form of a flat panel. The hinge connection unit 34 is formed at the back of the heater body 32. An electric heating tube 36 is installed inside the heater body 32.

The position adjustment link unit 110 is installed on the top surface of the support unit 102. A circular bearing 38 is formed at the bottom of the position adjustment link unit 110 on one side thereof. A bearing shaft 40 is upwardly protruded from the bearing 38. A connection link 42 is extended in one direction, that is, in the direction of a right side from the bearing shaft 40.

The bearing 38 may be installed so that it is inserted into the coupling fixing groove 14 having a concave groove and rotated.

Furthermore, an elevation bar 44 is upwardly extended at the end of the connecting link 42.

A male screw mount is formed in the elevation bar 44.

The temperature control unit 108 for controlling the temperature of the heating unit 106 for applying heat to cooking materials is installed in the left side of the connection pillar body 22. The temperature control unit 108 includes a power switch 46 for supplying power (not shown). A temperature control dial 48 for setting the temperature of the heater unit 106 is formed at the lower part of the power switch 46. A temperature display window 50 for displaying a set temperature is formed at the upper part of the temperature control dial 48 when the temperature is controlled.

The material support tool 112 on which cooking materials are placed so as to be heated by the heater are heated is installed at the lower part of the heater unit 106. The material support tool 112 includes a body 52 configured to be a form of a flat panel and to support cooking materials at the central portion of the body. A coupling hole 54 having a female screw is formed in the central part of the body 52.

Furthermore, a material support body 56 having a concave shape with an open top is formed on the left and right sides of the body 52. Side plates 58 are formed on both sides of the material support body 56. A plurality of fixing holes 60 is formed in the side plate 58.

Furthermore, a coupling hole 61 having a female screw therein is formed in the central part of the side plate 58.

A fixing piece 62 is provided in the inside of the material support body 56 at the back thereof. The fixing piece 62 is formed to be in the shape of a triangle, or one surface of the fixing piece 62 is formed to have a circular arc. Thus, the fixing piece 62 is preferably formed to support lumps of meat or half-moon lumps of cheese.

A coupling hole 64 is formed inside the fixing piece 62. A fixing means 66 may be fixed to the coupling hole 64. That is, after the coupling hole 64 is placed at the same position as the fixing hole 60, they may be fixed using the fixing means 66.

The material fixing means 114 as described above may be fixed to the material support body 56. The material fixing means 114 includes a material fixing body 68 configured to have the shape of flat panel and installed so that it is placed inside the material support body 56. An advance bar 70 having a screw mount therein is formed on one side of the material fixing body 68. The advance bar 70 is equipped with a handle 72.

A curved unit 67 is inwardly rounded at the bottom of the material fixing body 68, and functions to stably grasp cooking materials from the side.

As the handle 72 formed as mentioned above is rotated, the advance bar 70 moves forward. Thus, the material fixing body 68 moves forward to grasp cooking materials.

The advance bar 70 is preferably installed to be combined with the coupling hole 61 and moved.

FIG. 6 is a perspective view illustrating a state where the top heating type cooking apparatus according to the present invention is used and illustrates a state where half-moon-lumps of cheese of of various other cooking materials, such as boiled potatoes, french fries, sausages, hot dogs, and lumps of meat are used. Lumps of cheese 200 having a half-moon shape are placed on the material support tool 112 and then tightly grasped by one side of the material fixing means 114 by rotating the handle 72 of the material fixing means 114.

Furthermore, the back of the lumps of cheese 200 having a half-moon shape is supported by the fixing piece 62. The lumps of cheese 200 may be placed close to the heating unit 106 so that they are broiled from the top. In this case, when the material support tool 112 is rotated, the lumps of cheese 200 may be upwardly moved along the elevation bar 44 of the position adjustment link unit 112 and placed close to the heating unit 106. The heating temperature of the heating unit 106 is differently set depending on cooking materials. The temperature of the heating unit 106 is set by rotating the temperature control dial 48 of the temperature control unit 108. The lumps of cheese 200 installed as described above is heated and broiled from the top and scraped using a knife if they are suitably broiled to the extent that the materials of the lumps of cheese droop.

While some exemplary embodiments of the present invention have been described with reference to the accompanying drawings, those skilled in the art may change and modify the present invention in various ways without departing from the essential characteristics of the present invention. Accordingly, the disclosed embodiments should not be construed as limiting the technical spirit of the present invention, but should instead be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A top heating type cooking apparatus, comprising:
a support unit 102 which has a coupling fixed groove 14 on the top surface of a support plate 10 in the form of a flat panel;
a pillar unit 104 which includes a fixing pillar 16 fixed to the back of the support unit 102, and a connection pillar body 22 upwardly extended and installed in the fixing pillar 16, and which has hinge units 103 and 105 so that the top and bottom of the fixing pillar 16 and the connection pillar body 22 are hinged and rotatably moved;
a heating unit 106 which is connected to the hinge unit 105 of the pillar unit 104 to be rotatably move up and down and which provides heat to broil cooking materials from a top;
a position adjustment link unit 110 which is inserted and rotated into a coupling fixing groove 14 formed in the top surface of the support unit 102 and which is installed to fix the position of the cooking materials and to move up and down so that the cooking materials become close to the heater unit 106; and
a material support tool 112 which is fixed to the top of the position adjustment link unit 110 and which includes a material support body 56 and a side plate 58 to place and broil the cooking materials therein,
wherein the position adjustment link unit 110 includes:
a bearing 38 inserted into the coupling fixed groove 14, connected and rotated at one side of the position adjustment link unit 110;
a bearing shaft 40 upwardly protruded and connected to the bearing 38;
a connection link 42 fixed to the top of the bearing shaft 40 and laterally extended; and
an elevation bar 44 fixed to one end of the connection link 42 and upwardly extended.

2. The top heating type cooking apparatus of claim 1, further comprising:
a material fixing body 68 configured to apply lateral pressure to the cooking materials to fix them, wherein an advance bar 70 and a handle 72 are formed on one side of the material fixing body 68, and
a material fixing means 114 configured to move back and forth by rotating the handle 72, and apply pressure to fix the cooking materials.

3. The top heating type cooking apparatus of claim 1, further comprising a fixing piece 62 configured to be in a triangle shape and be fixed to the inside of the material support body 56 of the material support tool 112.
